(19) United States
(12) Patent Application Publication
(10) Pub. No.: US 2015/0256771 A1
(43) Pub. Date: Sep. 10, 2015

(54) SOLID-STATE IMAGING DEVICE

(71) Applicant: Kabushiki Kaisha Toshiba, Minato-ku (JP)

(72) Inventor: Masahiro SHIMURA, Fuchu (JP)

(73) Assignee: Kabushiki Kaisha Toshiba, Minato-ku (JP)

(21) Appl. No.: 14/633,643

(22) Filed: Feb. 27, 2015

(30) Foreign Application Priority Data
Mar. 4, 2014 (JP) 2014-042012

(51) Int. Cl. H04N 5/355; H04N 5/376; H04N 5/3745; H04N 5/378; H04N 5/374

(52) U.S. Cl. CPC H04N 5/355; H04N 5/378; H04N 5/3742; H04N 5/37455; H04N 5/3765

(57) ABSTRACT

According to one embodiment, a solid-state imaging device includes an ADC circuit configured to AD-convert signal components read from first pixels, based on a comparison result with a reference voltage superposed with a clamp voltage, and an AD clamp circuit configured to perform calculation, based on a relationship between an AD conversion value of a black level, which is read from light-shield pixels when a predetermined clamp voltage is given, and the clamp voltage, and further based on a change amount of the black level relative to the clamp voltage, wherein the calculation is to calculate a clamp voltage corresponding to a target value of a black level read from the light-shield pixel.

### CROSS-REFERENCE TO RELATED APPLICATIONS

This application is based upon and claims the benefit of priority from Japanese Patent Application No. 2014-42012, filed on Mar. 4, 2014; the entire contents of which are incorporated herein by reference.

### FIELD

Embodiments described herein relate generally to a solid-state imaging device.

### BACKGROUND

As a solid-state imaging device, there is a type provided with OB (Optical Black) pixels for setting a black level reference during imaging. According to the OB pixels, their dark voltage varies depending on use conditions, such as high temperature and/or high sensitivity, and the black level read from the OB pixels is thereby shifted. In order to compensate for such a shift of the black level, there is a case where a clamp voltage for AD conversion of a pixel signal is controlled by feedback until the black level read from the OB pixels converges onto a target value. In this feedback control, however, there is large variation of time necessary for the black level to converge onto a target value, and, as the case may be, the black level does not converge onto the target value within a time period defined by the frame rate.

### BRIEF DESCRIPTION OF THE DRAWINGS

FIG. 1 is a block diagram showing a schematic configuration of a solid-state imaging device according to a first embodiment;

FIG. 2 is a block diagram showing a schematic configuration of a CMOS sensor shown in FIG. 1;

FIG. 3 is a block diagram showing a schematic configuration of an AD clamp circuit shown in FIG. 1;

FIG. 4 is a timing chart showing an AD conversion operation of a pixel signal by a column ADC circuit shown in FIG. 2;

FIG. 5 is a view showing an example of a method of calculating a clamp voltage in the solid-state imaging device shown in FIG. 1;

FIG. 6 is a timing chart showing the waveform of a reference voltage when the clamp voltage shown in FIG. 5 is set; and

FIG. 7 is a block diagram showing a schematic configuration of a digital camera provided with a solid-state imaging device, according to a second embodiment.

### DETAILED DESCRIPTION

In general, according to one embodiment, a solid-state imaging device includes a first pixel zone, a light-shield pixel zone, an ADC circuit, and an AD clamp circuit. The first pixel zone is formed with first pixels. The light-shield pixel zone is formed with light-shield pixels. The ADC circuit is configured to AD-convert signal components read from the effective pixels, based on a comparison result with a reference voltage superposed with a clamp voltage. The AD clamp circuit is configured to perform calculation, based on a relationship between an AD conversion value of a black level, which is read from the light-shield pixels when a predetermined clamp voltage is given, and the clamp voltage, and further based on a change amount of the black level relative to the clamp voltage, wherein the calculation is to calculate a clamp voltage corresponding to a target value of a black level read from the light-shield pixel.

Exemplary embodiments of a solid-state imaging device will be explained below in detail with reference to the accompanying drawings. The present invention is not limited to the following embodiments.

### First Embodiment

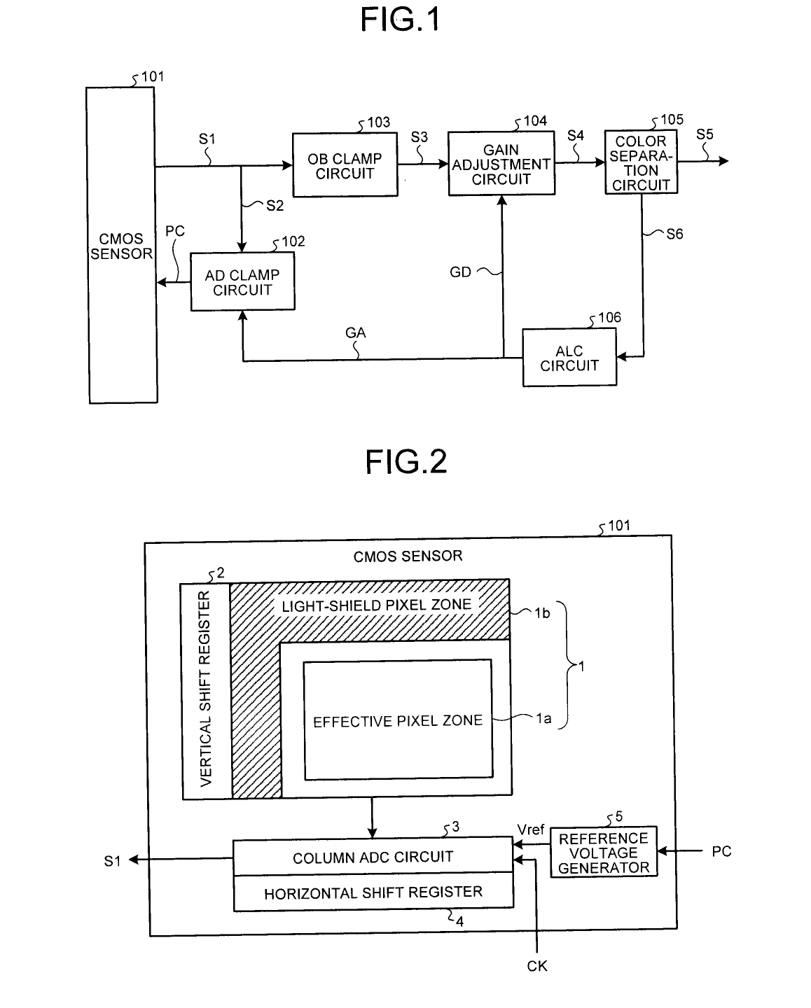

FIG. 1 is a block diagram showing a schematic configuration of a solid-state imaging device according to a first embodiment.

As shown in FIG. 1, this solid-state imaging device is provided with a CMOS sensor 101 for outputting an image signal S1, an AD clamp circuit 102, an OB clamp circuit 103, a gain adjustment circuit 104, a color separation circuit 105, and an automatic level control circuit 106. Here, for example, the filter arrangement of the CMOS sensor 101 may use a Bayer array, and the image signal S1 may be an RAW image signal.

The CMOS sensor 101 includes OB pixels for setting a black level reference during imaging, and effective pixels for outputting the image signal S1 based on photoelectric conversion. Further, the CMOS sensor 101 can AD-convert signal components read from the effective pixels, based on a comparison result with a reference voltage superposed with a clamp voltage. Here, the reference voltage can be switched in time division in accordance with a clamp voltage generation period and a ramp wave generation period.

The AD clamp circuit 102 can set a control parameter PC so that the black level read from the OB pixels of the CMOS sensor 101 matches a target value. Then, the control parameter PC can adjust the black level read from the OB pixels. Here, based on the relationship between an AD conversion value of a black level, which is read from the OB pixels when a predetermined clamp voltage is given, and the clamp voltage, and further based on a change amount of the black level relative to the clamp voltage, the AD clamp circuit 102 can calculate a clamp voltage corresponding to a target value of the black level read from the OB pixels. Further, it can give the relationship between an AD conversion value of the black level read from the OB pixels and the clamp voltage, as a linear function with an inclination defined by the change amount α of the black level relative to the clamp voltage. The change amount α can be uniquely determined from an analog gain GA given to the AD clamp circuit 102. Further, the predetermined clamp voltage can be merely a clamp voltage for one point, and it may be set to, e.g., 0V.

The OB clamp circuit 103 can clamp an image signal read from the effective pixels, based on the black level read from the OB pixels of the CMOS sensor 101.

The gain adjustment circuit 104 can adjust the white balance and/or the gain of an image signal S3 output from the OB clamp circuit 103. The parameters for adjusting the white balance and/or the gain may use a command set value and/or a digital gain GD.

The color separation circuit 105 can convert an image signal S4, output from the gain adjustment circuit 104, into a color separation signal S5. Here, the color separation signal S5 may be an RGB signal or YUV signal. At this time, the color separation circuit 105 can extract a luminance signal S6 from the image signal S4.

The automatic level control circuit 106 can adjust the screen luminance. At this time, the automatic level control circuit 106 can judge the screen brightness based on the luminance signal S6 and adjust the digital gain GD and the analog gain GA.

With this configuration, incident light from an imaging target is subjected to photoelectric conversion in the CMOS sensor 101. Then, an image signal S1 generated by the CMOS sensor 101 is output to the OB clamp circuit 103. Further, an OB signal S2 read from the OB pixels of the CMOS sensor 101 is output to the AD clamp circuit 102.

Then, in the OB clamp circuit 103, the image signal S1 is clamped based on the black level read from the OB pixels, and an image signal S3 is thereby generated and output to the gain adjustment circuit 104.

Then, in the gain adjustment circuit 104, the gain of the image signal S3 is adjusted based on a digital gain GD output from the automatic level control circuit 106, and an image signal S4 is thereby generated and output to the color separation circuit 105.

Then, in the color separation circuit 105, the image signal S4 is converted into a color separation signal S5, and a luminance signal S6 is extracted from the image signal S4 and output to the automatic level control circuit 106.

Then, in automatic level control circuit 106, the digital gain GD and the analog gain GA are adjusted based on the luminance signal S6, and then the digital gain GD is output to the gain adjustment circuit 104 and the analog gain GA is output to the AD clamp circuit 102.

Then, in the AD clamp circuit 102, during the clamp voltage generation period, a control parameter PC is set so that a predetermined clamp voltage is given, and this control parameter PC is output to the CMOS sensor 101. Then, an AD conversion value of the black level read from the OB pixels of the CMOS sensor 101 at this time is output as the OB signal S2 to the AD clamp circuit 102. Then, in the AD clamp circuit 102, based on the relationship between the AD conversion value of the black level at this time and the clamp voltage, and further based on a change amount α of the black level relative to the clamp voltage, a clamp voltage corresponding to a target value of the black level read from the OB pixels is calculated. Then, a control parameter PC is set so that the clamp voltage corresponding to the black level target value is given, and this control parameter PC is output to the CMOS sensor 101.

Further, in the AD clamp circuit 102, during the ramp wave generation period, a control parameter PC is set so that the ramp wave inclination is controlled in accordance with the analog gain GA, and this control parameter PC is output to the CMOS sensor 101. Then, in the CMOS sensor 101, signal components are AD-converted based on a clock count result obtained until the level of the signal components read from the effective pixels matches the level of the ramp wave.

As described above, the AD clamp circuit 102 can calculate a clamp voltage corresponding to a black level target value, by at least only once obtaining an AD conversion value of the black level when a predetermined clamp voltage is given. Thus, there is no need to control a clamp voltage for AD conversion of the pixel signal by feedback until the black level read from the OB pixels converges onto a target value. Consequently, the variation of time necessary for the black level to converge onto the target value can be reduced, and so the black level can converge onto the target value within a time period defined by the frame rate.

FIG. 2 is a block diagram showing a schematic configuration of the CMOS sensor shown in FIG. 1.

As shown in FIG. 2, the CMOS sensor 101 is provided with a pixel array section 1 in which pixels are arranged in a matrix format defined by a row direction and a column direction. Here, the pixel array section 1 includes an effective pixel zone 1a in which pixels are arranged in a matrix format defined by the row direction and the column direction, and a light-shield pixel zone 1b disposed around the effective pixel zone 1a. The effective pixel zone 1a is formed with effective pixels, and the light-shield pixel zone 1b is formed with light-shield pixels (OB pixels).

Further, the CMOS sensor 101 is provided with a vertical shift register 2 for scanning the pixel array section 1 in the vertical direction; a column ADC circuit 3 for digitalizing signal components read from the pixel array section 1, by use of CDS, based on a comparison result with a reference voltage Vref; a horizontal shift register 4 for scanning the pixel array section 1 in the horizontal direction; and a reference voltage generator 5 for generating the reference voltage Vref based on the control parameter PC. Here, the control parameter PC can set a clamp level and/or an inclination used for the reference voltage Vref. Further, the reference voltage Vref may use a ramp wave. Further, the reference voltage Vref may be superposed with a clamp voltage.

With this configuration, the pixels of the pixel array section 1 are scanned in the vertical direction by the vertical shift register 2, and a signal is thereby read from the pixels of the pixel array section 1 and sent to the column ADC circuit 3. Then, in column ADC circuit 3, signal components read from the pixel array section 1 are digitalized by use of CDS and are scanned in the horizontal direction by the horizontal shift register 4, and the image signal S1 is thereby output.

Here, a counter clock CK is input to the column ADC circuit 3 in the ramp wave generation period. Then, the signal components are AD-converted based on a count result of the counter clock CK obtained until the level of the signal components read from the effective pixel zone 1a matches the level of the ramp wave.

Further, the AD clamp circuit 102 can set a control parameter PC so that the dark current of the OB pixels is canceled at the clamp level of the reference voltage Vref during AD conversion by the column ADC circuit 3.

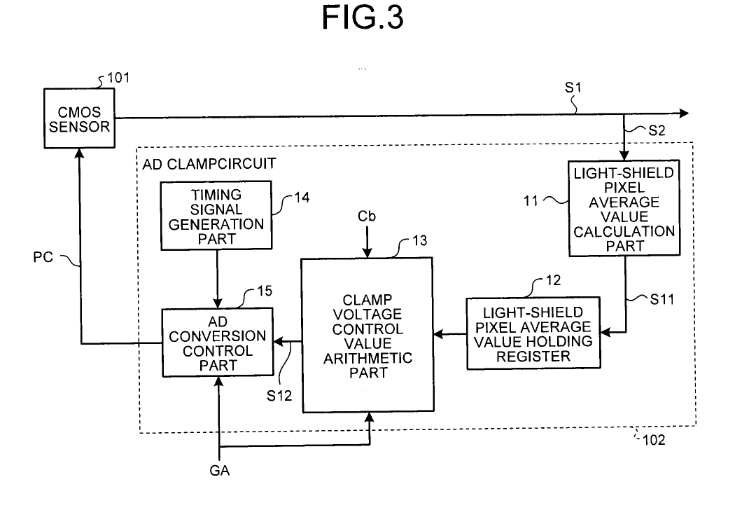

FIG. 3 is a block diagram showing a schematic configuration of the AD clamp circuit shown in FIG. 1.

As shown in FIG. 3, the AD clamp circuit 102 includes a pixel average value calculation part 11, a light-shield pixel average value holding register 12, a clamp voltage control value arithmetic part 13, a timing signal generation part 14, and an AD conversion control part 15.

Here, upon switching to the clamp voltage generation period by the timing signal generation part 14, a control parameter PC is set by the AD conversion control part 15 so that a predetermined clamp voltage is given, and this control parameter PC is output to the CMOS sensor 101. Then, in the CMOS sensor 101, when the predetermined clamp voltage is given, a black level read from the light-shield pixel zone 1b is AD-converted, and an OB signal S2 is thereby generated and input to the pixel average value calculation part 11. Then, in the pixel average value calculation part 11, the OB signal S2 at this time is averaged for every horizontal line, and an HOB (Horizontal Optical Black) pixel average value S11 is thereby calculated, and is held in the light-shield pixel average value holding register 12.

Then, in the clamp voltage control value arithmetic part 13, based on an HOB pixel average value S11 obtained when a predetermined clamp voltage is given, and further based on a change amount α of the black level relative to the clamp voltage, a clamp voltage control value S12 corresponding to a black level target value Cb is calculated and output to the AD conversion control part 15.

Then, in the AD conversion control part 15, a control parameter PC is set based on the clamp voltage control value S12 so that a clamp voltage corresponding to the black level target value Cb is given, and this control parameter PC is output to the CMOS sensor 101.

On the other hand, upon switching to the ramp wave generation period by the timing signal generation part 14, a control parameter PC is set so that the ramp wave inclination is controlled in accordance with the analog gain GA, and this control parameter PC is output to the CMOS sensor 101.

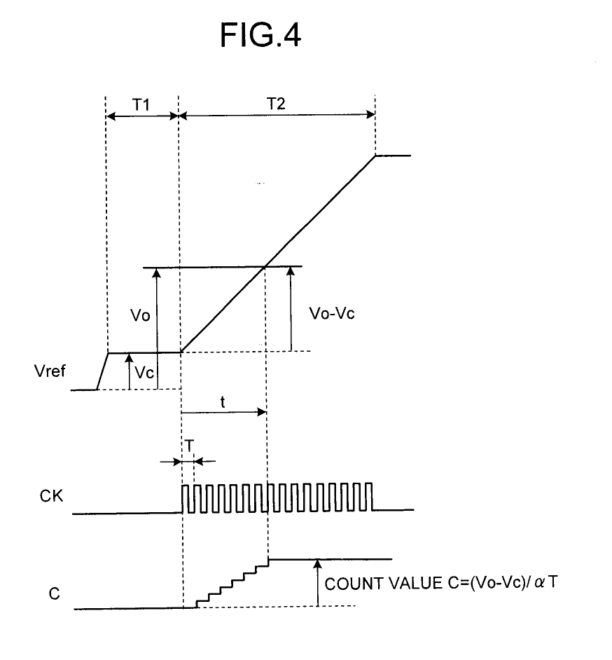

FIG. 4 is a timing chart showing an AD conversion operation of a pixel signal by the column ADC circuit shown in FIG. 2.

As shown in FIG. 4, the reference voltage Vref is switched in time division in accordance with the clamp voltage generation period T1 and the ramp wave generation period T2. Here, in the clamp voltage generation period T1, the reference voltage Vref is kept at a clamp voltage Vc. In the ramp wave generation period T2, a ramp wave is given as the reference voltage Vref, and the counter clock CK is input. At this time, the ramp wave inclination is given as dV/dt=α, which is equal to a change amount α of the black level relative to the clamp voltage.

Then, where the pixel voltage of an image signal S1 read from the effective pixel zone 1a is given as Vo, an AD-converted signal component Vp is given as Vo−Vc. Then, the counter clock CK is counted until the level of the pixel voltage Vo read from the effective pixel zone 1a matches the level of the ramp wave, and the count value C obtained at this time is output as an AD conversion value of the signal component Vp=Vo−Vc. Here, where T denotes the cycle of the counter clock CK, the count value C at this time is expressed by (Vo−Vc)/(αT).

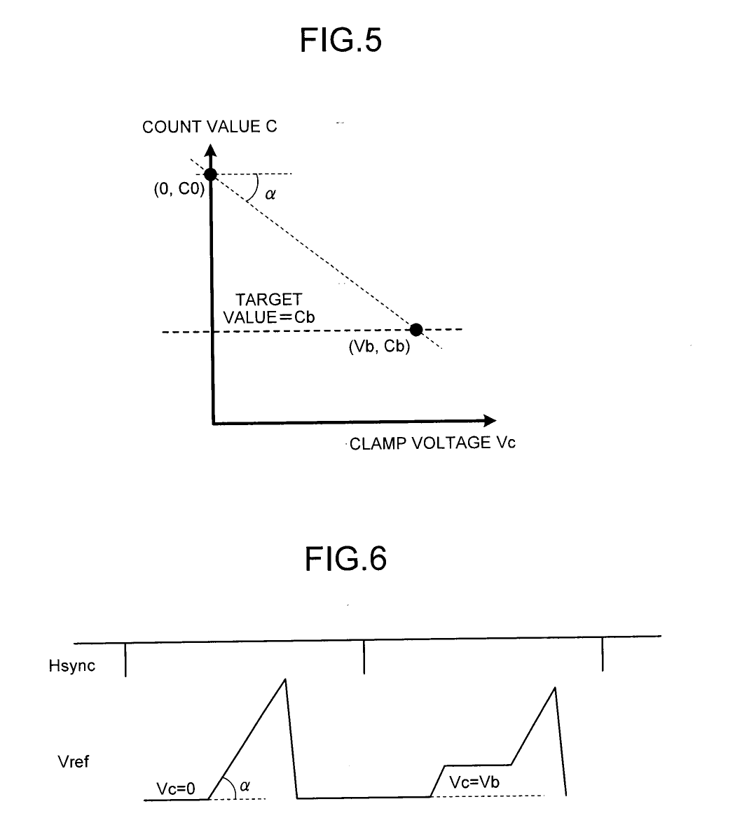

FIG. 5 is a view showing an example of a method of calculating the clamp voltage in the solid-state imaging device shown in FIG. 1. It should be noted that this example shows a method of calculating a clamp voltage Vb corresponding to the black level target value Cb, based on a count value C0 and a change amount α, which are set by using a clamp voltage Vc and giving one point of Vc=0V to obtain the count value C0.

Specifically, the relationship between the count value C and the clamp voltage Vc can be expressed by a linear function shown in the following formula (1), based on the count value C0 obtained by giving one point of Vc=0V, where a denotes the voltage change amount of the ramp wave voltage per unit time.

c=−αVc+C0 (1)

From the formula (1), the clamp voltage Vb corresponding to the black level target value Cb can be expressed by the following formula (2).

Vb=(C0−Cb)/α (2)

When an AD conversion value is calculated by use of a clamp voltage for one point in accordance with the formula (2), a clamp voltage for giving a desired black level data output can be determined without using any feedback system.

FIG. 6 is a timing chart showing the waveform of a reference voltage when the clamp voltage shown in FIG. 5 is set.

As shown in FIG. 6, the clamp voltage Vc is set to 0V at the first one of a vertical synchronous signal Hsync. Then, the count value C0 is obtained by giving one point of Vc=0V, and the clamp voltage Vb corresponding to the black level target value Cb is calculated based on the count value C0 and the change amount α at this time. Then, the clamp voltage Vc is set to the clamp voltage Vb corresponding to the target value Cb at the second one of the vertical synchronous signal Hsync.

### Second Embodiment

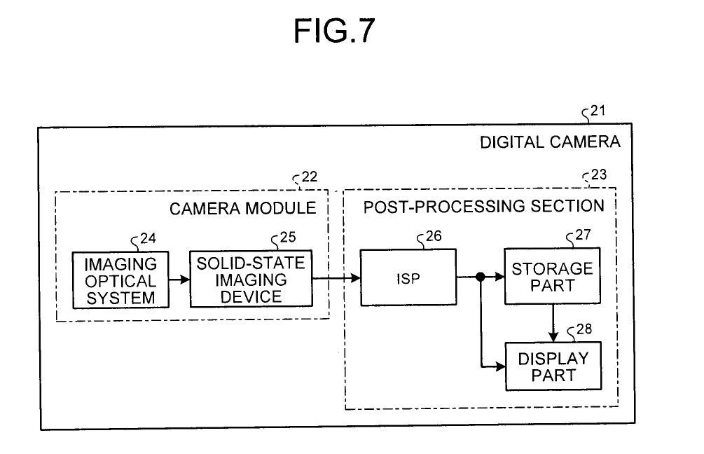

FIG. 7 is a block diagram showing a schematic configuration of a digital camera provided with a solid-state imaging device, according to a second embodiment.

As shown in FIG. 7, the digital camera 21 is composed of a camera module 22 and a post-processing section 23. The camera module 22 includes an imaging optical system 24 and a solid-state imaging device 25. The post-processing section 23 includes an image signal processor (ISP) 26, a storage part 27, and a display part 28. Here, the solid-state imaging device 25 may have the configuration shown in FIG. 1. Further, at least part of the structure of the ISP 26 may be integrated with the solid-state imaging device 25 to form one chip. Further, the AD clamp circuit 102, the OB clamp circuit 103, the gain adjustment circuit 104, the color separation circuit 105, and the automatic level control circuit 106 may be arranged in the ISP 26.

The imaging optical system 24 takes in light from an imaging target and condenses it to a target image. The solid-state imaging device 25 images the target image. The ISP 26 performs signal processing to the image signal obtained by the imaging of the solid-state imaging device 25. The storage part 27 stores the image subjected to the signal processing by the ISP 26. The storage part 27 outputs an image signal to the display part 28 in accordance with user operations or the like. The display part 28 displays an image corresponding to an image signal input from the ISP 26 or storage part 27. For example, the display part 28 is formed of a liquid crystal display. It should be noted that the camera module 22 may be applied to an electronic device other than the digital camera 2, such as a camera attached mobile phone or smart phone.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A solid-state imaging device comprising:
a first pixel zone formed with first pixels;
a light-shield pixel zone formed with light-shield pixels;
an ADC circuit configured to AD-convert signal components read from the first pixels, based on a comparison result with a reference voltage superposed with a clamp voltage; and
an AD clamp circuit configured to perform calculation, based on a relationship between an AD conversion value of a black level, which is read from the light-shield pixels when a predetermined clamp voltage is given, and the clamp voltage, and further based on a change amount of the black level relative to the clamp voltage, wherein the calculation is to calculate a clamp voltage corresponding to a black level target value of a black level read from the light-shield pixel.

2. The solid-state imaging device according to claim 1, wherein the AD clamp circuit is configured to give the relationship between an AD conversion value of a black level read from the light-shield pixels and the clamp voltage, as a linear function with an inclination defined by the change amount.

3. The solid-state imaging device according to claim 2, wherein the AD clamp circuit is configured to give a clamp voltage for one point, as the predetermined clamp voltage.

4. The solid-state imaging device according to claim 3, wherein the change amount is uniquely determined from an analog gain given to the AD clamp circuit.

5. The solid-state imaging device according to claim 4, wherein the reference voltage is switched in time division in accordance with a clamp voltage generation period and a ramp wave generation period.

6. The solid-state imaging device according to claim 5, wherein the ADC circuit is configured to AD-convert the signal components, based on a clock count result obtained until a level of the signal components matches a level of a ramp wave, in the ramp wave generation period.

7. The solid-state imaging device according to claim 1, wherein the AD clamp circuit is configured to set a control parameter so that the black level becomes closer to the target value, and the reference voltage is set based on the control parameter.

8. The solid-state imaging device according to claim 1, wherein the AD clamp circuit is configured to calculate the clamp voltage corresponding to the black level target value, by at least only once obtaining an AD conversion value of a black level when the predetermined clamp voltage is given.

9. The solid-state imaging device according to claim 1, comprising:
an OB (Optical Black) clamp circuit configured to clamp an image signal read from the first pixels, based on a black level read from the light-shield pixels;
a gain adjustment circuit configured to adjust a gain of an image signal output from the OB clamp circuit, based on a digital gain;
a color separation circuit configured to convert an image signal, output from the gain adjustment circuit, into a color separation signal; and
an automatic level control circuit configured to adjust the digital gain and an analog gain, based on the color separation signal.

10. The solid-state imaging device according to claim 1, wherein the AD clamp circuit includes
a pixel average value calculation part configured to calculate an HOB (Horizontal Optical Black) pixel average value by averaging a black level read from the light-shield pixels for every horizontal line,
a light-shield pixel average value holding register configured to hold the HOB pixel average value,
a clamp voltage control value arithmetic part configured to calculate a clamp voltage control value corresponding to the black level target value, based on the HOB pixel average value and the change amount, and
an AD conversion control part configured to set a control parameter for giving a clamp voltage corresponding to the black level target value, based on the clamp voltage control value.

11. A solid-state imaging device comprising:
a CMOS sensor to which a clamp voltage corresponding to a black level target value is given; and
an AD clamp circuit configured to calculate a clamp voltage corresponding to the black level target value, based on a value of a black level read from the CMOS sensor when a predetermined clamp voltage is given, and further based on a change amount of the black level relative to the clamp voltage.

12. The solid-state imaging device according to claim 11, wherein the AD clamp circuit is configured to calculate a clamp voltage corresponding to the black level target value, based on a linear function that has an inclination defined by a change amount of the black level relative to the clamp voltage, and passes through a value for one point of a black level read from the CMOS sensor when the clamp voltage is given.

13. The solid-state imaging device according to claim 12, wherein the change amount is uniquely determined from an analog gain.

14. The solid-state imaging device according to claim 13, comprising:
an OB clamp circuit configured to clamp an image signal read from first pixels, based on a black level read from the CMOS sensor;
a gain adjustment circuit configured to adjust a gain of an image signal output from the OB clamp circuit, based on a digital gain;
a color separation circuit configured to convert an image signal, output from the gain adjustment circuit, into a color separation signal; and
an automatic level control circuit configured to adjust the digital gain and the analog gain, based on the color separation signal.

15. The solid-state imaging device according to claim 14, wherein the CMOS sensor includes
a light-shield pixel zone formed with light-shield pixels, from which the black level is read;
a first pixel zone formed with first pixels, from which a pixel signal is read; and
an ADC circuit configured to AD-convert signal components read from the first pixels, based on a comparison result with a reference voltage superposed with the clamp voltage.

16. The solid-state imaging device according to claim 15, wherein the AD clamp circuit includes
a pixel average value calculation part configured to calculate an HOB pixel average value by averaging a black level read from the CMOS sensor for every horizontal line,
a light-shield pixel average value holding register configured to hold the HOB pixel average value,
a clamp voltage control value arithmetic part configured to calculate a clamp voltage control value corresponding to the black level target value, based on the HOB pixel average value and the change amount, and
an AD conversion control part configured to set a control parameter for giving a clamp voltage corresponding to the black level target value, based on the clamp voltage control value.

17. The solid-state imaging device according to claim 16, wherein the AD clamp circuit includes a timing signal generator configured to switch in time division between a clamp voltage generation period and a ramp wave generation period.

18. The solid-state imaging device according to claim 17, wherein the AD conversion control part is configured to set the control parameter so that a predetermined clamp voltage is given in the clamp voltage, generation period.

19. The solid-state imaging device according to claim 18, wherein the AD conversion control part is configured to set a control parameter so that an inclination of a ramp wave of the reference voltage is controlled in accordance with the analog gain in the ramp wave generation period.

20. The solid-state imaging device according to claim 19, wherein the ADC circuit is configured to AD-convert the signal components, based on a clock count result obtained until a level of the signal components matches a level of the ramp wave, in the ramp wave generation period.
